(19) United States
(12) Patent Application Publication
(10) Pub. No.: US 2026/0063445 A1
(43) Pub. Date: Mar. 5, 2026

(54) DRIVER ASSISTANCE DEVICE, DRIVER ASSISTANCE SYSTEM, AND DRIVER ASSISTANCE METHOD

(71) Applicants: DENSO CORPORATION, Kariya-city (JP); J-QuAD DYNAMICS Inc., Tokyo (JP)

(72) Inventors: Satoshi HORIHATA, Kariya-city (JP); Yusuke MATSUMOTO, Tokyo (JP); Keisuke HACHISUKA, Tokyo (JP)

(21) Appl. No.: 19/311,686

(22) Filed: Aug. 27, 2025

(30) Foreign Application Priority Data
Aug. 30, 2024 (JP) 2024-148083

(51) Int. Cl. G01C 21/00; B60W 50/00; B60W 60/00

(52) U.S. Cl. CPC G01C 21/3848; B60W 50/0097; B60W 60/001; B60W 2556/40; B60W 2556/65

(57) ABSTRACT

A driver assistance device includes a map generation unit, a localizer, and a controller. The map generation unit uses a coordinate position of a first vehicle and surrounding information representing a target present around the first vehicle, as detected by a surrounding monitoring sensor installed in the first vehicle, to generate map information containing a coordinate position of a road. The localizer works to determine a predicted travel position that is a coordinate position to which the first vehicle is expected to travel to. The controller uses generated map information that is the map information generated by the map generation unit to perform a driver assistance task for the first vehicle moving toward the predicted travel position. When the generated map information containing the predicted travel position is determined to be unusable, the controller uses external map information that is map information obtained from outside the first vehicle and contains the predicted travel position in performing the driver assistance task for the first vehicle. This structure ensures the stability in achieving driver assistance for the first vehicle even when the generated map information is unusable.

### CROSS REFERENCE TO RELATED DOCUMENT

The present application claims the benefit of priority of Japanese Patent Application No. 2024-148083 filed on Aug. 30, 2024, the disclosure of which is incorporated in its entirety herein by reference.

### TECHNICAL FIELD

This disclosure relates generally to a driver assistance device, a driver assistance system, and a driver assistance method.

### BACKGROUND ART

As a driver assistance device, a technique is known in which autonomous driving is performed using high-precision map information. Japanese Patent No. 6358156 discloses a technique in which, in a section of a planned travel route where high-precision map information is not available, operation is switched to a manual driving mode. Japanese First Publication No. 2022-105410 discloses a technique in which a first autonomous driving mode using a first high-precision map is switched to a second autonomous driving mode using a second map lower in accuracy than the first map.

### Problem to be Solved by the Invention

There is a demand to perform driver assistance using map information generated using outputs from sensors mounted on a vehicle. A technique is desired that enables driver assistance for a vehicle even when the vehicle is at locations where the generated map information is not available.

This disclosure has been made in order to solve the above problem. Such problem solving is achieved by the following aspect.

According to one aspect of this disclosure, there is provided a driver assistance device includes a map generation unit, a localizer, and a controller. The map generation unit uses a coordinate position of a first vehicle and surrounding information representing a target present around the first vehicle, as detected by a surrounding monitoring sensor installed in the first vehicle, to generate map information containing a coordinate position of a road. The localizer works to determine a predicted travel position that is a coordinate position to which the first vehicle is expected to travel to. The controller uses generated map information that is the map information generated by the map generation unit to perform a driver assistance task for the first vehicle moving toward the predicted travel position. When the generated map information containing the predicted travel position is determined to be unusable, the controller uses external map information that is map information obtained from outside the first vehicle and contains the predicted travel position in performing the driver assistance task for the first vehicle.

The above-described structure ensures the stability in achieving driver assistance for the first vehicle using the external map information obtained from outside the first vehicle even when the generated map information is unusable.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a schematic diagram which illustrates the structure of a driver assistance system according to an embodiment;

FIG. 2 is a flowchart of a map generation program to generate map information for use in a driver assistance task; and

FIG. 3 is a flowchart of a driver assistance program to perform driver assistance control for a vehicle.

### DESCRIPTION OF THE PREFERRED EMBODIMENT

### First Embodiment

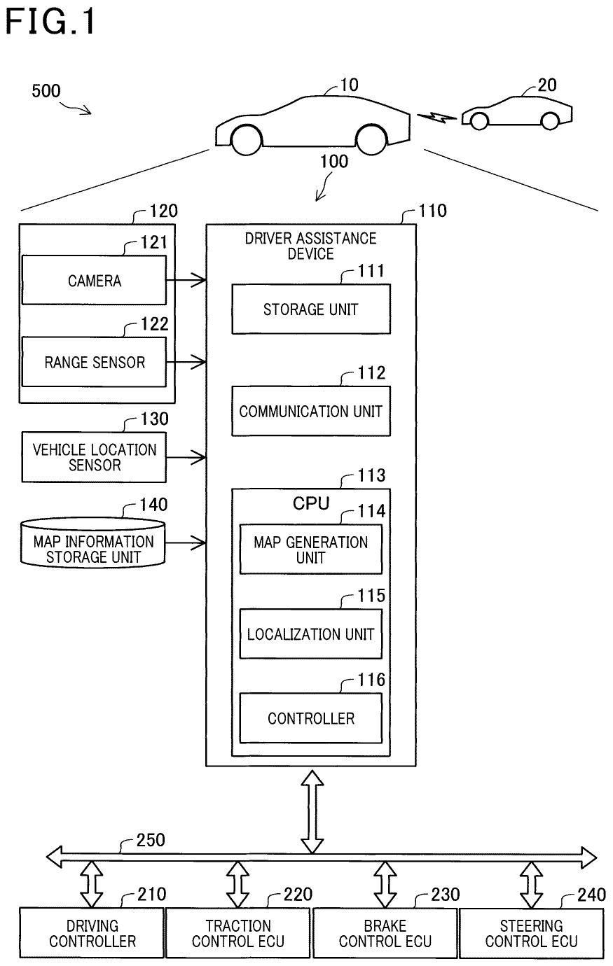

The driver assistance system 500, as illustrated in FIG. 1, includes the first vehicle 10, the second vehicle 20, and the driver assistance device 110. The driver assistance device 110 is mounted in the first vehicle 10. The driver assistance device 110 works to assist a driver in driving the first vehicle 10. The second vehicle 20 is an automotive vehicle present around the first vehicle 10.

The first vehicle 10 is equipped with the autonomous driving system 100. The autonomous driving system 100 works to perform autonomous driving of the first vehicle 10 as a form of driver assistance. The autonomous driving system 100 includes the driver assistance device 110, the surrounding monitoring sensor 120, the vehicle location sensor 130, the map information storage unit 140, the driving controller 210, the traction control ECU (Electronic Control Unit) 220, the brake control ECU 230, and the steering control ECU 240. The driver assistance device 110, the traction control ECU 220, the brake control ECU 230, and the steering control ECU 240 are connected to each other through the in-vehicle network 250. It should be noted that the first vehicle 10 is not limited to autonomous driving and may be driven manually by a driver or human operator.

The surrounding monitoring sensor 120 is a sensor working to detect an object located in the vicinity of the first vehicle 10 and output information about the object. The surrounding monitoring sensor 120 includes the camera 121 and the range sensor 122. The camera 121 captures images of the surroundings of the first vehicle 10 to acquire image data. The range sensor 122 measures the distance to an object present around the first vehicle 10. The range sensor 122 may be implemented by a LIDAR (Light Detection and Ranging) or a millimeter wave radar which is designed to utilize waves reflected from an object. In the present embodiment, the range sensor 122 identifies an object located in the vicinity of the first vehicle 10 and measures the distance to the identified object.

The vehicle location sensor 130 is configured to obtain a current coordinate position of the first vehicle 10. The vehicle location sensor 130 may be implemented by a Global Navigation Satellite System (GNSS), such as a Global Positioning System (GPS).

The map information storage unit 140 is configured to store map information about a versatile SD map (Standard Definition Map) and map information generated by the driver assistance device 110. The term “map information” refers to information indicating, for example, positions of various features or roads. The SD map, as referred to herein, comprises two-dimensional map data about latitude and longitude of map components, whereas the generated map information comprises three-dimensional map data including latitude and longitude of map components. The SD map is known as a conventional digital map used primarily for human navigation and general location-based services, such as car navigation systems, mobile applications, and geographic information services. Unlike a high definition (HD) map used in autonomous driving, the SD map usually offers low resolution and less detailed spatial data, typically with meter-level accuracy. The SD map contains only road links which represent segments of roads and are equivalent to those found in standard navigation maps. The map information (i.e., road network information) representing the SD map is simplified map information in the form of points and lines, and although it retains basic road shape data, the geometric accuracy is low. The map information is lower in accuracy than the map information generated by the driver assistance device 110, and does not include detailed information which refers to data at the lane level. A map that includes such lane-level information is commonly referred to as a high definition (HD) map. The detailed information not included in the SD map is generated by the driver assistance device 110 and stored in the map information storage unit 140.

The driver assistance device 110 works to control traveling of the first vehicle 10 in a driver assistance mode. The driver assistance device 110 includes the storage unit 111, the communication unit 112, and the CPU 113. The CPU 113 implements functions of the map generation unit 114, the localization module 115, and the controller 116 by executing programs pre-installed in the storage unit 111. However, some or all of the functions of these units may alternatively be implemented by hardware circuits.

The communication unit 112 performs vehicle-to-vehicle communication with the second vehicle 20. The first vehicle 10 can acquire various types of information from the second vehicle 20 by performing the vehicle-to-vehicle communication. The communication unit 112 may be designed to perform at least one type of communication among: wireless communication with an Intelligent Transport System (ITS), vehicle-to-vehicle communication with the second vehicle 20, and vehicle-to-infrastructure communication with roadside units or other road-installed equipment.

The map generation unit 114 generates map information usable for driver assistance control by the driver assistance device 110, described later, using the coordinate position of the first vehicle 10 acquired from the vehicle location sensor 130 and information about surrounding environments acquired from the surrounding monitoring sensor 120. The map information usable for driver assistance control refers to high-precision map data that is more detailed than an SD map, and may include, for example, the positions of lane markings and traffic signs, the width of the road, the number of lanes, the location of intersections, and the angles between intersecting roads. The map generation unit 114 generates, for example, map information including the coordinate positions of roads. More specifically, the map generation unit 114 calculates the coordinate positions of surrounding objects or targets located around or near the first vehicle 10 using the coordinate position of the first vehicle 10 and the surrounding information, and generates map information in association with respective map objects stored in the map information storage unit 140.

The map generation unit 114 associates a calculated coordinate position to each target appearing at a given location in the SD map information where the map information has never been generated by the map generation unit 114. Specifically, the map generation unit 114 associates coordinate positions of boundaries of a lane on a road in the SD map with information about that road in the SD map. Furthermore, in a case where map information has already been generated at a given location, the map generation unit 114 associates the calculated coordinate position with a corresponding target in the generated map information.

The localization module 115 (which will also be referred to below as a localizer) works to acquire a predicted travel position, which is a coordinate position that the first vehicle 10 is expected to travel to. The localization module 115 obtains the predicted travel position using a coordinate position of the first vehicle 10 and a travel direction of the first vehicle 10, the coordinate position being acquired from the vehicle location sensor 130. Additionally, the localization module 115 may acquire the predicted travel position based on route information indicating a route from a current location of the first vehicle 10 to a destination thereof, the route information being generated by the driver assistance device 110 or another device, for example, in response to a driver setting the destination.

The controller 116 performs driver assistance control for the first vehicle 10 to travel toward a planned travel position by using the map information generated by the map generation unit 114. In this embodiment, the controller 116 performs a given autonomous driving task that causes the first vehicle 10 to travel to the planned travel position.

When the generated map information including the planned travel position is not available, the controller 116 uses external map information which is obtained outside the first vehicle 10 and includes the planned travel position to perform the operation of the first vehicle 10 in the driver assistance mode. For instance, the controller 116 acquires the external map information from the second vehicle 20, which has generated the external map information. The second vehicle 20, similarly to the first vehicle 10, generates the external map information based on the coordinate position of the second vehicle 20 and surrounding information detected by the surrounding monitoring sensor 120 mounted on the second vehicle 20.

The driving controller 210 is composed of a microcomputer including a central processing unit (CPU), a RAM, and a ROM, and implements autonomous driving functions by executing a pre-installed program on the microcomputer. The driving controller 210 implements the autonomous driving function to allow the first vehicle 10 to travel to the planned travel position by controlling the traction control ECU 220, the brake control ECU 230, and the steering control ECU 240 under the control of the controller 116. For example, the driving controller 210 controls the traction control ECU 220 and the brake control ECU 230, and performs automatic lane changes using the steering control ECU 240.

The traction control ECU 220 is an electronic control unit configured to control a power source, such as an engine, for producing a driving force or torque to move the first vehicle 10. In a manual mode in which the driver manually operates the first vehicle 10, the traction control ECU 220 controls the power source, such as an internal combustion engine or an electrical motor, as a function of a driver's effort on an accelerator pedal. Alternatively, in an autonomous driving mode, the traction control ECU 220 controls the power source as a function of a required driving force or torque calculated by the driving controller 210.

The brake control ECU 230 is an electronic control unit that controls a brake actuator configured to generate a braking force for the first vehicle 10. When the driver manually operates the first vehicle 10, the brake control ECU 230 controls the brake actuator as a function of a degree to which a brake pedal is depressed by the driver in the first vehicle 10. Alternatively, when the first vehicle 10 is in the autonomous driving mode, the brake control ECU 230 controls the brake actuator as a function of a required braking force calculated by the driving controller 210.

The steering control ECU 240 is an electronic control unit that controls a motor configured to generate steering torque for the first vehicle 10. When the driver manually operates the first vehicle 10, the steering control ECU 240 controls the motor as a function of a driver's effort on a steering wheel of the first vehicle 10, thereby generating assist torque corresponding to the steering operation. This enables the driver to steer the first vehicle 10 with a reduced steering effort. Alternatively, When the vehicle is in the autonomous driving mode, the steering control ECU 240 controls the motor based on a required steering angle calculated by the driving controller 210, thereby performing steering control for the first vehicle 10.

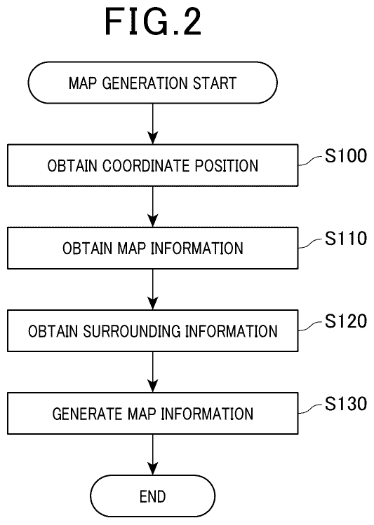

FIG. 2 illustrates a map generation task or program executed when the map generation unit 114 is required to generate the map information. The map generation program is executed cyclically at an interval of, for example, 100 ms by the driver assistance device during movement of the first vehicle 10. This task will also be referred to below as a map generation step. The following discussion will refer to an example where map information is produced at a location where the map information has never been generated by the map generation unit 114.

After entering the program in FIG. 2, the routine proceeds to step S100 wherein the map generation unit 114 obtains a current coordinate position of the first vehicle 10 from the vehicle location sensor 130.

The routine then proceeds to step S110 wherein the map generation unit 114 obtains map information about the SD map (will also be referred to below as SD map information) including the coordinate position of the first vehicle 10, as derived in step S100, from the map information storage unit 140.

The routine then proceeds to step S120 wherein the map generation unit 114 obtains surrounding information from the surrounding monitoring sensor 120. The order in which the operations in steps S100 to S120 are performed may be changed as long as the operation in step S110 is performed after step S100. Steps S100 to S120 may also be performed in parallel to each other.

The routine proceeds to step S130 wherein the map generation unit 114 analyzes the coordinate position of the first vehicle 10, as derived in step S100, and the surrounding information, as derived in step S120, to calculate a coordinate position defined by coordinates of latitude and longitude of each of objects or targets present around the first vehicle 10 and generates an item of map information about each of such targets in relation to a corresponding one of the targets in the SD map information derived in step S100. The map information storage unit 140 stores therein the map information generated by the map generation unit 114.

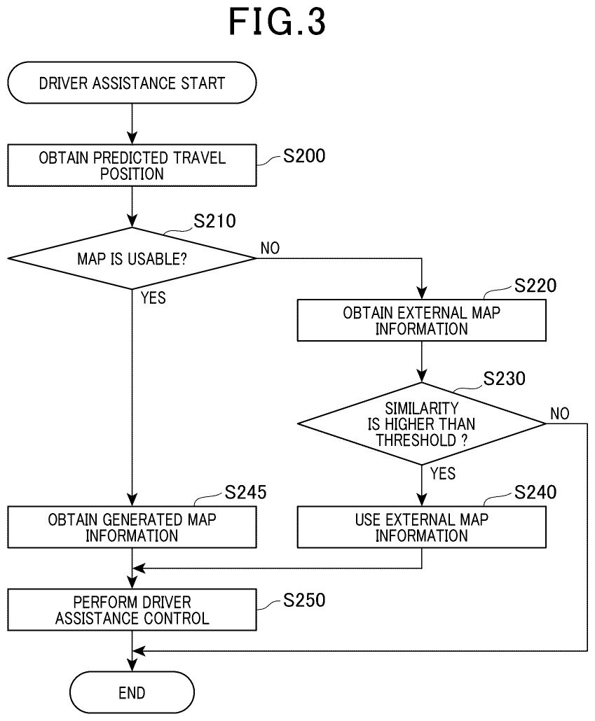

FIG. 3 shows a driver assistance task or program through which the driver assistance device 110 assists in driving the first vehicle 10. This program is executed cyclically at an interval of, for example, 100 ms by the driver assistance device 110 when the first vehicle 10 is moved in the autonomous driving mode.

After entering the program, the routine proceeds to step S200 wherein the localization module 115 performs a position information obtaining step to obtain or calculate a predicted travel position of the first vehicle 10. Specifically, the localization module 115 analyzes the current coordinate position, as obtained from the map generation unit 114, and a travelling direction that is a direction in which the first vehicle 10 is heading to calculate the predicted travel position of the first vehicle 10.

The routine proceeds to step S210 wherein the controller 116 determines whether the generated map information including the predicted travel position, as obtained in step S200, is usable. If a YES answer is obtained meaning that the generated map information is usable, in other words, the map information has been produced which is usable in the driver assistance mode of the first vehicle 10, then the routine proceeds to step S245. Alternatively, if a NO answer is obtained meaning that no map information has been produced for use in the driver assistance mode of the first vehicle 10, then the routine proceeds to step S220.

In step S220, the driver assistance device 110 fetches, from the second vehicle 20, external map information including the predicted travel position determined in step S200.

The routine proceeds to step S230 wherein the driver assistance device 110 determines whether the external map information, as retrieved in step S220, is similar to the generated map information. Specifically, the driver assistance device 110 determines whether a measure of similarity between a pre-selected element contained in the generated map information and a corresponding element contained in the external map information is higher than or equal to a given threshold.

The measure or degree of similarity, as referred to in this embodiment, represents a value indicative of the degree of similarity of driving patterns or driving behaviors of vehicles. Usually, in a case where there is a tendency for a vehicle to travel predominantly on the right side of the longitudinal center of a lane, the coordinates (e.g., latitude and longitude) of a white line painted on the left boundary of the lane in the width direction of the lane are more likely to vary compared to the coordinates of a white line painted on the right boundary of the lane. Accordingly, the driver assistance device 110 determines the degree of similarity in driving behaviors based on the similarity between a variation tendency of the white line coordinates included in the generated map information and a variation tendency of the white line coordinates included in the external map information.

If a YES answer is obtained in step S230 meaning that the degree of similarity is higher than or equal to the given threshold, then the driver assistance device 110 proceeds to step S240. Alternatively, if a NO answer is obtained in step S230 meaning that the degree of similarity is lower than the given threshold, then the driver assistance device 110 terminates the driver assistance task.

In step S240, the driver assistance device 110 uses the external map information analogous or corresponding to the generated map information as a map for the driver assistance mode of the first vehicle 10.

If a YES answer is obtained in step S210 meaning that the generated map information is usable, then the routine proceeds to step S245 wherein the driver assistance device 110 obtains the generated map information containing the predicted travel position, as derived in step S200, from the map information storage unit 140.

The routine proceeds to step S250 wherein the controller 116 uses the generated map information provided in step S245 or the external map information provided in step S240 to control the operation of the first vehicle 10 in the driver assistance mode. Specifically, the controller 116 uses the map information to determine contents of the driver assistance control for the first vehicle 10 to output them to the driving controller 210. For instance, the driver assistance device 110 analyzes the map information and determines a controlled speed of the first vehicle 10 according to a speed limit on a planned path contained in the map information. A combination of the operations in steps S210 to S250 will also be referred to below as a driver assistance control step.

As apparent from the above discussion, the driver assistance device 110 in this embodiment is capable of performing the driver assistance using the map information generated by the device itself. This facilitates the driver assistance in the autonomous driving mode without having to prepare high-precision map information in advance. Even in areas where the generated map information is not available, the driver assistance device 100 is also capable of using the external map information to achieve the driver assistance in the autonomous driving mode.

The driver assistance device 110 uses the external map information whose degree of similarity to the generated map information is higher than or equal to the given threshold in the driver assistance mode, thereby resulting in an increased likelihood that the driver assistance using the generated map information and the driver assistance using the external map information will resemble each other. It is, therefore, highly probable that the sense of incongruity during switching between driving of the first vehicle 10 assisted by the generated map information and driving of the first vehicle 10 assisted by the external map information may be suppressed.

The similarity, as referred to above, represents the degree to which the driving behavior of the first vehicle 10 resembles that of the second vehicle 20. Accordingly, since it becomes possible to perform the driver assistance using the external map information generated by the second vehicle 20 exhibiting similar driving behavior, there is a high likelihood that the sense of incongruity during switching between the manual driving mode of the first vehicle 10 or the autonomous driving mode using the generated map information, and the autonomous driving mode using the external map information, can be suppressed.

### MODIFICATIONS

### First Modification

The driver assistance device 110 in the above-described embodiment is installed in the first vehicle 10, but however, may alternatively be arranged in an external server or an infrastructure provided outside the first vehicle 10.

### Second Modification

The driver assistance system 500 may be designed not to include the second vehicle 20. In this case, the driver assistance device 110 obtains the external map information from a road facility, such as a traffic signal or a variable message sign, or a communication device installed in, for example, a commercial facility or a public facility.

### Third Modification

The driver assistance system 500 may be designed to have a plurality of second vehicles 20. In this case, the driver assistance device 110 selects one of a plurality of items of external map information received from the second vehicles 20 and uses it in performing the driver assistance for the first vehicle 10. For instance, the driver assistance device 110 selects one of the items of the external map information which is the highest in accuracy or above-described degree of similarity.

### Fourth Modification

In the driver assistance task in the above-described embodiment, the driver assistance device 110 utilizes the external map information whose degree of similarity is higher than or equal to the given threshold for performing the driver assistance task, but however, the driver assistance device 110 may be designed to exclude the operation in step S230 (see FIG. 3). In this case, in step S240, the driver assistance device 110 uses the external map information, as obtained in step S220, for the driver assistance task for the first vehicle 10 regardless of the degree of similarity thereof. The driver assistance device 110 may alternatively use the external map information whose accuracy is higher than a given threshold in the driver assistance task for the first vehicle 10.

### Fifth Modification

The degree of similarity, as referred to in the above-described embodiment, represents a value indicative of the degree of similarity between driving behaviors (e.g., driving patterns) of vehicles. Specifically, the degree of similarity is defined by the degree of similarity between a variation tendency of white line coordinates included in the generated map information and a variation trend of white line coordinates included in the external map information. The degree of similarity may alternatively be defined by a measure of similarity between variations in white lane coordinates in the generated map information and the external map information regardless of the driving behaviors of vehicles or a measure of similarity in trend of coordinate deviations of respective objects or targets (e.g., map features) in a yaw-axis direction thereof. The degree of similarity may alternatively be defined by a measure of similarity between accuracies of the generated map information and the external map information. For instance, map information containing data about a speed limit or a traffic restriction of a road which is indicated by a traffic sign is defined to be higher in accuracy than that containing no such data.

### Sixth Modification

The driver assistance device 110 in the above-described embodiment may be designed to obtain information about a driving behavior or pattern of a vehicle (e.g. the second vehicle 20) in addition to the external map information. In this case, the driver assistance device 110 may determine the degree of similarity using the information about the driving behavior.

### Seventh Modification

The driver assistance task in the above-described embodiment is a task performed cyclically while the first vehicle 10 is moved in the autonomous driving mode, but however, it may be performed at the start of autonomous driving of the first vehicle 210 from the current location to a destination. In this case, in step S200 (see FIG. 3), the localization module 115 acquires each coordinate position along the planned travel route to the destination as a predicted travel position. Furthermore, the controller 116 may acquire external map information including predicted travel positions where the generated map information is unavailable within the planned travel route, and determine the external map information to be used for driver assistance control for each predicted travel position.

This disclosure is not limited to the above embodiments, but may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure.

The driver assistance device 110 in this disclosure or how to perform the functions of the driver assistance device 110 may be realized by a special purpose computer which is equipped with a processor and a memory and programmed to execute one or a plurality of tasks created by computer-executed programs or alternatively established by a special purpose computer equipped with a processor made of one or a plurality of hardware logical circuits. The controllers or operations thereof referred to in this disclosure may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium.

1. A driver assistance device comprising:
a map generation unit which uses a coordinate position of a first vehicle and surrounding information representing a target present around the first vehicle, as detected by a surrounding monitoring sensor installed in the first vehicle, to generate map information containing a coordinate position of a road;
a localizer which works to determine a predicted travel position that is a coordinate position to which the first vehicle is expected to travel to; and
a controller which uses generated map information that is the map information generated by the map generation unit to perform a driver assistance task for the first vehicle moving toward the predicted travel position, in response to the generated map information containing the predicted travel position being determined to be unusable, the controller uses external map information that is map information obtained from outside the first vehicle and contains the predicted travel position in performing the driver assistance task for the first vehicle.

2. The driver assistance device as set forth in claim 1, wherein the driver assistance task is performed using the external map information exhibiting a degree of similarity higher than or equal to a given threshold, the degree of similarity being a measure of similarity between a pre-selected element contained in the generated map information and a corresponding element contained in the external map information.

3. The driver assistance device as set forth in claim 2, wherein the external map information is produced by a second vehicle which is different from the first vehicle,
the elements contained in the generated map information and the external map information include driving patterns of the first vehicle and the second vehicle.

4. A driver assistance system comprising:
a first vehicle in which a surrounding monitoring sensor is installed;
a second vehicle present around the first vehicle;
a map generation unit which uses a coordinate position of the first vehicle and surrounding information representing a target present around the first vehicle, as detected by the surrounding monitoring sensor, to generate map information containing a coordinate position of a road;
a localizer which works to determine a predicted travel position that is a coordinate position to which the first vehicle is expected to travel to; and
a controller which uses generated map information that is the map information generated by the map generation unit to perform a driver assistance task for the first vehicle moving toward the predicted travel position, in response to the generated map information containing the predicted travel position being determined to be unusable, the controller uses external map information that is map information obtained from outside the first vehicle and contains the predicted travel position in performing the driver assistance task for the first vehicle.

5. A driver assistance method comprising:
a map generation step of using a coordinate position of a first vehicle and surrounding information representing a target present around the first vehicle, as detected by a surrounding monitoring sensor installed in the first vehicle, to generate map information containing a coordinate position of a road;
a position information obtaining step of obtaining a predicted travel position that is a coordinate position to which the first vehicle is expected to travel to; and
a driver assistance control step of, when there is generated map information that is the map information which is generated in the map generation step and contains the predicted travel position, using the generated map information to perform a driver assistance task for the first vehicle moving toward the predicted travel position, in response to the generated map information containing the predicted travel position being determined to be unusable, the driver assistance control step using external map information that is map information obtained from outside the first vehicle and contains the predicted travel position in performing the driver assistance task for the first vehicle.
